(19) United States
(12) Patent Application Publication
(10) Pub. No.: US 2023/0281565 A1
(43) Pub. Date: Sep. 7, 2023

(54) SYSTEM AND METHOD FOR GENERATING LOWER-DIMENSION GRAPH REPRESENTATIONS IN TALENT ACQUISITION PLATFORMS

(71) Applicant: HireTeamMate Incorporated, Mountain View, CA (US)

(72) Inventors: Yu ZHOU, Springfield, NJ (US); Sijian WANG, New Brunswick, NJ (US); Xinwen ZHANG, San Ramon, CA (US)

(21) Appl. No.: 17/686,897

(22) Filed: Mar. 4, 2022

(51) Int. Cl. G06Q 10/10; G06F 16/901; G06F 16/906

(52) U.S. Cl. CPC G06Q 10/1053; G06F 16/9024; G06F 16/906

(57) ABSTRACT

A method for generating lower-dimension graph representations is disclosed. The may include obtaining a graph having at least one primary node, a plurality of secondary nodes, and a plurality of edges connecting the at least one primary node to the plurality of secondary nodes. Further, the method may include determining the graph as at least one of a sparse graph or a dense graph, using primary connectivity data and secondary connectivity data associated with the graph; and augmenting the graph with the secondary connectivity data to produce an augmented graph, based on the graph being the sparse graph. The secondary connectivity data may be indicative of a set of knowledge graphs associated with the plurality of secondary nodes. Furthermore, the method may include generating the lower-dimension graph representations for the augmented graph.

### FIELD

The present disclosure generally relates to talent acquisition platforms and more particularly relates to a system and a method for generating lower-dimension graph representations in the talent acquisition platforms.

### BACKGROUND

Talent acquisition is a process that includes recruiting, tracking, and/or interviewing job candidates to onboard new employees. Usually, the talent acquisition process is performed by employers (also referred to as talent acquisition professionals). This talent acquisition process is a challenging task and in some instances the talent acquisition process may turn-out to be an unproductive task, because of un-surety of outcome of the talent acquisition process, that is to say, whether candidate data or candidate profile that the talent acquisition professionals are gathering, viewing, analyzing, and shortlisting are actually best fit or not, is very uncertain. Further, with numerous data channels, such as job postings, referrals, professional networks, social networks, job boards and the like, talent acquisition professionals are inundated with a large volume of data of candidate profiles, with very less time and computing resources available at their hands.

Currently, there are some available techniques that aim to address the aforementioned problems by aggregating data volumes associated with the talent acquisition process from a plurality of sources and further filtering the data volumes based on some predefined criteria. But due to size of the data volumes, these available techniques may fail to be efficient. There are also some other techniques that aim to process large data volumes in an efficient way. These some other techniques process the large data volumes by representing the large data volumes as graphs and generating embedding for the graphs. For instance, the generated embedding of the graphs may be lower-dimension graph representations of the graphs. However, these some other techniques may fail to process the large data volumes that correspond to large data volumes associated with data having diverse types.

Accordingly, there is a need for a system and a method that generates the lower-dimension graph representations in an efficient manner.

### SUMMARY

Generally, the available techniques fail to process the large data volumes associated with diverse or heterogeneous types, such as data related to the talent acquisition process, because of the following reasons. Firstly, to generate the embedding, the available techniques consider entities of the graphs to be of one-specific category. But this consideration may fail for the large data volumes associated with the talent acquisition process, because the talent acquisition process may have entities of multiple categories. Secondly, the available techniques aim to generate the embedding that embeds all entities in the graphs, but it may be unnecessary to embed all entities in the graphs for the large data volumes associated with the talent acquisition process. Further, in some cases, the graphs that represent data volumes associated with the talent acquisition process may be sparse. In these cases, the available techniques fail to provide accurate and reliable graph embeddings, and consequently, inaccurate, less useful, or sparse data for the talent acquisition professionals.

In order to solve the foregoing problems, it is an objective of some embodiments to provide accurate and reliable data for the talent acquisition professionals. In order to provide the accurate and reliable data, some embodiments aim to determine the graph as at least one of sparse graph or dense graph and produce an augmented graph when the graph is determined as the sparse graph. Further, the lower-dimension graph representations may be generated for the augmented graph to provide accurate and reliable data for the talent acquisition professionals.

It is also objective of some embodiment to determine a node-category associated with the graph before producing the augmented graph. In some embodiments, the node-category may be determined as homogeneous node-category that is indicative of entities of one-specific category. In some other embodiments, the node-category may be determined as heterogeneous node-category that is indicative of entities of multiple categories. Various embodiments are provided for producing the augmented graph based on the determination of the node-category as at least one of the homogeneous node-category and the heterogeneous node-category.

It is also objective of some embodiments to select at least two node-types defining a sub-graph in the augmented graph and generate the lower-dimension graph representations for the sub-graph within the augmented graph. Accordingly, in these embodiments, the lower-dimension graph representations may be generated in an efficient manner, since the lower-dimension graph representations are generated for a sub-graph within the augmented graph.

In one aspect, a method for generating the lower-dimension graph representations is disclosed. The method comprises obtaining a graph having: (i) at least one primary node, (ii) a plurality of secondary nodes, and (iii) a plurality of edges connecting the at least one primary node to the plurality of secondary nodes and determining the graph as at least one of a sparse graph or a dense graph, using primary connectivity data and secondary connectivity data associated with the graph. Further, the method comprises augmenting the graph with the secondary connectivity data to produce an augmented graph, based on the graph being the sparse graph, where the secondary connectivity data is indicative of a set of knowledge graphs associated with the plurality of secondary nodes. Furthermore, the method comprises generating the lower-dimension graph representations for the augmented graph.

In additional method embodiments, determining the graph as at least one of the sparse graph or the dense graph comprises: determining that each of the plurality of edges is at least one of: (i) a primary connection defined by the primary connectivity data or (i) a secondary connection defined by the secondary connectivity data; classifying the graph as the dense graph, in response to determining that at least one edge of the plurality edges is the secondary connection defined by the secondary connectivity data; or classifying the graph as the sparse graph, in response to determining that each of the plurality of edges is a respective primary connection defined by the primary connectivity data.

In additional method embodiments, augmenting the graph with the secondary connectivity data comprises determining a node-category associated with the graph based on the plurality of secondary nodes, where the node-category corresponds to at least one of a heterogeneous node-category or a homogeneous node-category.

In additional method embodiments, the at least one primary node corresponds to at least one primary recruiting entity and the plurality of secondary nodes correspond to at least one of: (i) a plurality of candidate entities or (ii) a plurality of secondary recruiting entities.

In additional method embodiments, determining the node-category associated with the graph comprises: determining the node-category as the heterogeneous node-category when the plurality of secondary nodes corresponds to the plurality of candidate entities; or determining the node-category as the homogeneous node-category when the plurality of secondary nodes corresponds to the plurality of secondary recruiting entities.

In additional method embodiments, when the node-category of the graph corresponds to the homogeneous node-category, augmenting the graph with the secondary connectivity data further comprises: obtaining a first set of knowledge graphs as the secondary connectivity data, where the first set of knowledge graphs comprises one or a combination of: a competitor graph or a j ob hopping graph associated with the plurality of secondary recruiting entities; and based on the first set of knowledge graphs, augmenting the graph with one or more secondary edges to produce the augmented graph, where each of the one or more secondary edges is indicative of a secondary connection between the at least one primary node and the plurality of secondary nodes.

In additional method embodiments, augmenting the graph with the one or more secondary edges comprises executing a first operation on the graph and the first set of knowledge graphs to identify the one or more secondary edges, where the first operation defines random walks on at least two or more of: (i) the graph, (ii) the competitor graph, or (iii) the job hopping graph.

In additional method embodiments, when the node-category of the graph corresponds to the heterogeneous node-category, augmenting the graph with the secondary connectivity data further comprises: obtaining a second set of knowledge graphs as the secondary connectivity data, where the second set of knowledge graphs comprises a knowledge graph associated with each of the plurality of candidate entities; and based on the second set of knowledge graphs, augmenting the graph with (i) a plurality of tertiary nodes and (ii) a plurality of tertiary edges to produce the augmented graph.

In additional method embodiments, generating the lower-dimension graph representations for the augmented graph comprises: selecting at least two node-types in the augmented graph, where the at least two node-types define a sub-graph within the augmented graph; and generating the lower-dimension graph representations for the sub-graph defined within the augmented graph.

In additional method embodiments, the method further comprises executing a second operation on the augmented graph to produce the lower-dimension graph representations for the sub-graph, where the second operation distinguishes one node-type of the at least two node-types from another node-type of the at least two node-types in the produced lower-dimension graph representations.

In additional method embodiments, the method further comprises generating the lower-dimension graph representations for the graph, based on the graph being the dense graph.

In additional method embodiments, the method further comprises: obtaining a search query indicative of one or a combination of skill data, educational data, location data, job role data, or company name data; generating one or more results for the search query, using the generated lower-dimension graph representations; and outputting the one or more results corresponding to the search query.

In another aspect, a system for generating lower-dimension graph representations is disclosed. The system comprises: a memory configured to store computer-executable instructions; and at least one processor configured to execute the computer-executable instructions to: obtain a graph having: (i) at least one primary node, (ii) a plurality of secondary nodes, and (iii) a plurality of edges connecting the at least one primary node to the plurality of secondary nodes; determine the graph as at least one of a sparse graph or a dense graph, using the primary connectivity data and secondary connectivity data associated with the graph; based on the graph being the sparse graph, augment the graph with the secondary connectivity data to produce an augmented graph, where the secondary connectivity data is indicative of a set of knowledge graphs associated with the plurality of secondary nodes; and generate the lower-dimension graph representations for the augmented graph.

In yet another embodiment, a computer program product comprising a non-transitory computer readable medium having stored thereon computer executable instruction which when executed by at least one processor, cause the at least one processor to carry out operations for generating lower-dimension graph representations, the operation comprising: obtaining a graph having: (i) at least one primary node, (ii) a plurality of secondary nodes, and (iii) a plurality of edges connecting the at least one primary node to the plurality of secondary nodes; determining the graph as at least one of a sparse graph or a dense graph, using primary connectivity data and secondary connectivity data associated with the graph; based on the graph being the sparse graph, augmenting the graph with the secondary connectivity data to produce an augmented graph, where the secondary connectivity data is indicative of a set of knowledge graphs associated with the plurality of secondary nodes; and generating the lower-dimension graph representations for the augmented graph.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Having thus described example embodiments of the invention in general terms, reference will now be made to the accompanying drawings, which are not necessarily drawn to scale, and wherein:

FIG. 1A illustrates a block diagram showing a network environment of a system for generating lower-dimension graph representations, in accordance with one or more example embodiments;

FIG. 1B illustrates a block diagram of a database for storing processed talent information, in accordance with one or more example embodiments;

FIG. 2A illustrates a block diagram of the system for generating the lower-dimension graph representations, in accordance with one or more example embodiments;

FIG. 2B illustrates a schematic diagram showing graphs obtained by the system, in accordance with one or more example embodiments;

FIG. 2C illustrates a schematic diagram for producing an augmented graph when a node-category corresponds to a homogenous node-category, in accordance with one or more example embodiments;

FIG. 2D illustrates a schematic diagram for producing an augmented graph when the node-category corresponds to a heterogeneous node-category, in accordance with one or more example embodiments;

FIG. 2E illustrates a flowchart for outputting one or more results corresponding to a search query, in accordance with one or more example embodiments;

FIG. 3 illustrates a flowchart showing a method for generating the lower-dimension graph representations, in accordance with one or more example embodiments; and

FIG. 4 illustrates a block diagram of a user equipment for accessing a talent acquisition platform, in accordance with one or more example embodiments.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses, systems, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analogue circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), may be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

A system, a method, and a computer program product are provided for generating the graph embedding in the talent acquisition platforms. It is an objective of the system and the method disclosed herein to provide accurate and reliable data for the talent acquisition professionals. In order to provide the accurate and reliable data, the system and the method disclosed herein aim to determine the graph as at least one of sparse graph or dense graph and produce an augmented graph when the graph is determined as the sparse graph. Further, the lower-dimension graph representations may be generated for the augmented graph to provide accurate and reliable data for the talent acquisition professionals. It is also objective of the system and the method disclosed herein to determine node-category associated with the graph before producing the augmented graph. In some embodiments, the node-category may be determined as homogeneous node-category that is indicative of entities of one-specific category. In some other embodiments, the node-category may be determined as heterogeneous node-category that is indicative of entities of multiple categories. Various embodiments are provided for producing the augmented graph based on the determination of the node-category as at least one of the homogeneous node-category and the heterogeneous node-category. It is also objective of the system and the method disclosed herein to select at least two node-types defining a sub-graph in the augmented graph and generate the lower-dimension graph representations for the sub-graph within the augmented graph. Accordingly, the system and the method disclosed herein may generate the lower-dimension graph representations in an efficient manner.

These and various other advantages of the systems and methods disclosed herein will be apparent from the detailed description provided herein, in conjunction with the various accompanying figures described below.

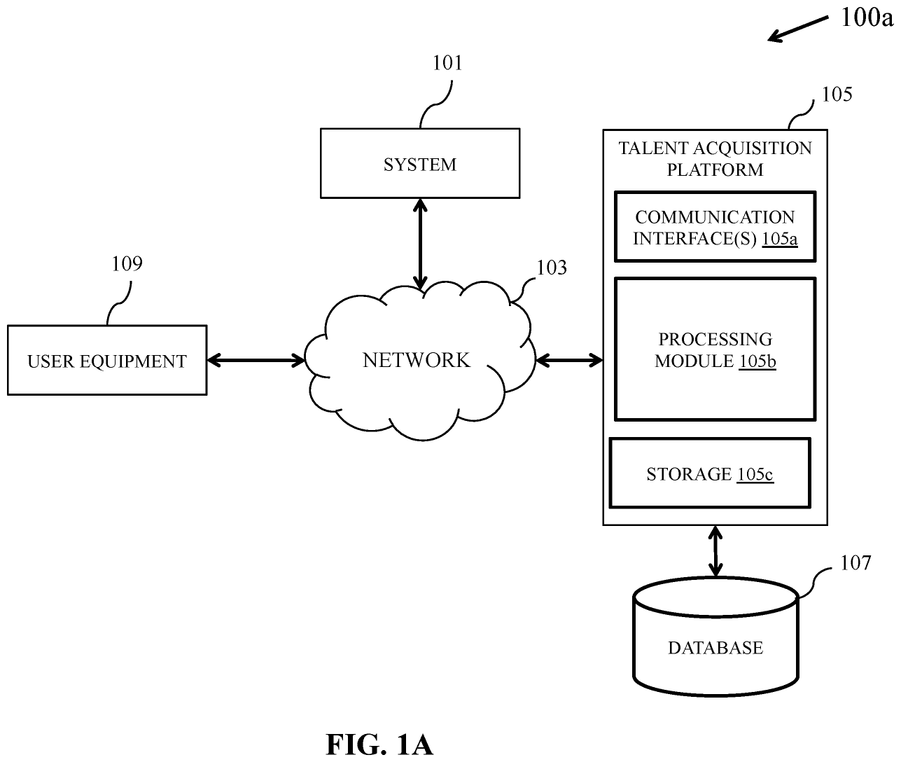

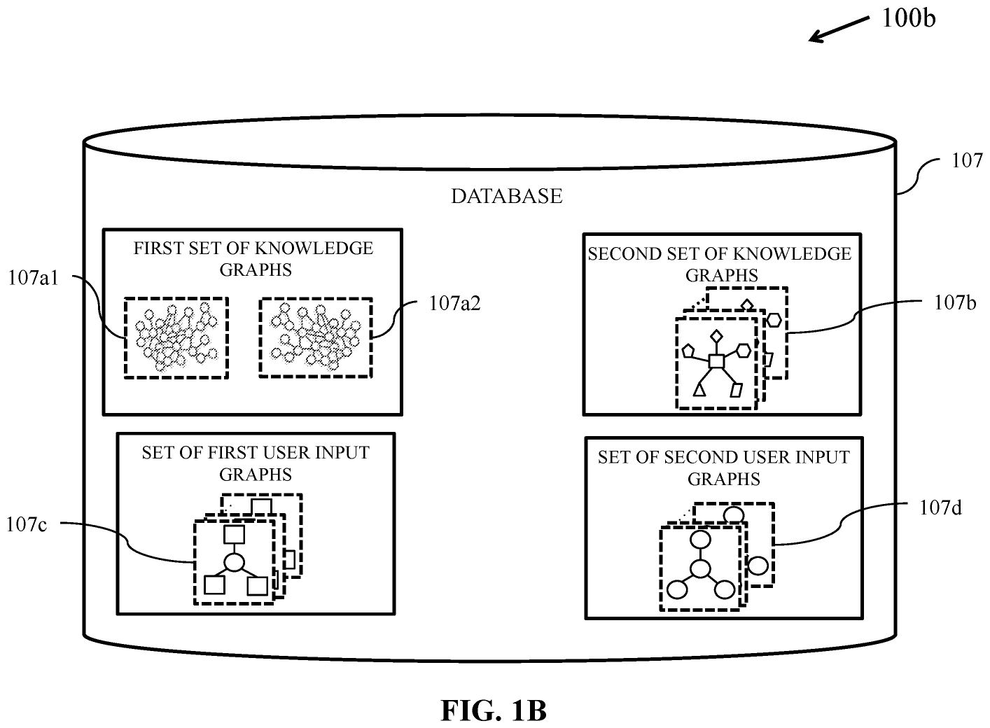

FIG. 1A illustrates a block diagram 100a showing a network environment of a system 101 for generating lower-dimension graph representations, in accordance with one or more example embodiments. As illustrated in FIG. 1A, the block diagram 100a may include the system 101, a network 103, a talent acquisition platform 105, a database 107, and a user equipment 109. The system 101 may be communicatively coupled, via the network 103, to the talent acquisition platform 105 and/or the user equipment 109. The talent acquisition platform 105 may be further coupled to the database 107. For exemplary purpose, the block diagram 100a including a single user equipment is considered. However, it may be possible that more than one user equipment may be coupled to the system 101 and/or the talent acquisition platform 105. Further, it may be possible that one or more components may be rearranged, changed, added, and/or removed without deviating from the scope of the present disclosure.

For example, the system 101 may be embodied in one or more of several ways as per the required implementations. For instance, the system 101 may be may be embodied as a cloud-based service, a cloud-based application, a cloud-based platform, a remote server-based service, a remote server-based application, a remote server-based platform, or a virtual user equipment. As such, the system 101 may be configured to operate inside the talent acquisition platform 105 and/or inside the user equipment 109.

In some embodiments, the system 101 may be embodied within the user equipment 109, for example, as a talent acquisition system, a talent acquisition app in a mobile device, or the like. In each of such embodiments, the system 101 may be communicatively coupled to the components shown in FIG. 1A to carry out the desired operations and whatever required modifications may be possible within the scope of the present disclosure. For instance, the user equipment 109 may be any user accessible device such as a mobile phone, a smartphone, a portable computer, a personal computer, a laptop, a tablet, a personal digital assistant (PDA), and the like. The user equipment 109 may comprise a processor, a memory, and a communication interface. The processor, the memory, and the communication interface may be communicatively coupled to each other. The user equipment 109 may be associated with one or more talent acquisition professionals and/or one or more candidates. As used herein, ‘talent acquisition professionals’ may correspond to Human Resource (HR) managers, hiring professionals, or the like who are scouting for candidates to their organization. As used herein, ‘candidate’ may correspond to a job seeker, an active job applicant who is actively looking for a job, a passive job applicant who is not actively looking for a job or may even be an employee of an organization.

In some other embodiments, the system 101 may be embodied within the talent acquisition platform 105. In each of such embodiments, the talent acquisition platform 105 may be communicatively coupled to the user equipment 109 and/or one or more other components external to the talent acquisition platform 105, via the network 103.

The network 103 (also referred to as a communication network 103) may be wired, wireless, or any combination of wired and wireless communication networks, such as cellular, Wi-Fi, internet, local area networks, or the like. In one embodiment, the network 103 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fibre-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof.

The talent acquisition platform 105 may include one or more communication interfaces 105a for gathering talent information from the user equipment 109 and/or one or more other components external to the talent acquisition platform 105. For instance, the one or more communication interfaces 105a may include an input interface and an output interface. Further, the talent acquisition platform 105 may include a processing module 105b and a storage 105c. The processing module 105b may be embodied as a microprocessor, a coprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. The storage 105c may be embodied as a ROM (read-only memory), a RAM (random access memory), a hard-disk, or the like. According to an embodiment, the storage 105c stores computer-executable instructions, which when executed by the processing module 105b may cause the processing module 105b to carry out various functions in accordance with one or more example embodiments of the present disclosure. Additionally, the storage 105c may also store one or more models such as machine learning (ML) models, neural network models, deep neural network models, and/or the like which may be pre-trained to carry out various functions in accordance with one or more example embodiments of the present disclosure. In an example embodiment, upon executing the storage 105c, the processing module 105b may process the talent information (e.g., data volumes) and store the processed talent information in the database 107. As used herein, ‘talent information’ may include one or more of recruiter data, candidate profile data, and/or user input data. For instance, the processing module 105b may separately process and store each of the recruiter data, the candidate profile data, and/or the user input data in the database 107. For example, the database 107 storing the processed talent information is as illustrated in FIG. 1B.

FIG. 1B illustrates a block diagram 100b of the database 107 for storing the processed talent information, in accordance with one or more example embodiments. FIG. 1B is explained in conjunction with FIG. 1A. As illustrated in FIG. 1B, the database 107 may store a first set of knowledge graphs 107a1 and 107a2, a second set of knowledge graphs 107b, a set of first user input graphs 107c, and a set of second user input graphs 107d. According to an embodiment, the first set of knowledge graphs 107a1 and 107a2 may include a competitor graph 107a1 and a job hopping graph 107a2. The competitor graph 107a1 may include multiple nodes and multiple edges. In the competitor graph 107a1, each node may correspond to one particular recruiting entity that is indicative of a particular organization (or a particular talent acquisition professional representing their organization). In the competitor graph 107a1, each edge connecting two nodes may indicate that two organizations represented by the two nodes are competitors. In an embodiment, the competitor graph 107a1 may be generated by the processing module 105b by processing the recruiter data associated with a plurality of organizations. For example, the recruiter data associated with one particular organization may include various recruiting data fields representing data about the organization such as name of the organization, one or more products developed by the organization, a field of the organization, a location of the organization, number of employees of the organization, and the like. In an example embodiment, the processing module 105b may generate the competitor graph 107a1 by comparing the various recruiting data fields associated with the plurality of organizations. For example, a similarity score may be computed for one particular pair of organizations by comparing (i) the various recruiting data fields associated with a first organization of the particular pair of organizations with (ii) the various recruiting data fields associated with a second organization of the particular pair of organizations. Further, if the similarity score is greater than a threshold score, then an edge may be formulated between two nodes representing the particular pair of organizations. In an alternate embodiment, the talent acquisition platform 105 may acquire competitor list data indicative of a competitor list, where each element in the competitor list may include two or more organizations that are competitors. In this embodiment, the processing module 105b may generate the competitor graph 107a1 by processing the competitor list data.

Additionally, the talent acquisition platform 105 may acquire job hopping data indicative of a job hopping list, where each element in the job hopping list may include at least two organizations in which same candidate(s) have worked in two different time periods. In an embodiment, the processing module 105b may generate the job hopping graph 107a2 by processing the job hopping data. The job hopping graph 107a2 may include multiple nodes and multiple edges. In the job hopping graph 107a2, each node may correspond to one particular recruiting entity that is indicative of a particular organization. In the job hopping graph 107a2, each edge connecting two nodes (i.e., two organizations) may indicate that at least one candidate have worked in both the organizations.

In an embodiment, the processing module 105b may generate the second set of knowledge graphs 107b by processing the candidate data associated with the plurality of candidates. For example, the candidate data associated with one particular candidate may correspond to a candidate profile of that particular candidate. For instance, the candidate profile may include various candidate data fields representing data about the candidate such as an identity of the candidate, one or more skills of the candidate, one or more organization in which the candidate has worked, age of the candidate, gender of the candidate, nationality of candidate, contact details of the candidate, public profile links of the candidate, a location of the candidate, and the like. In an example embodiment, the processing module 105b may generate the second set of knowledge graphs 107b such that each knowledge graph of the second set of knowledge graphs 107b is associated with a respective candidate of the plurality of candidates. Each knowledge graph 107b may include a first node, a plurality of second nodes, and a plurality of edges connecting the first node to the plurality of second nodes. For instance, the first node may correspond to the identity of the candidate that is indicative of the candidate entity. For instance, the plurality of second nodes may correspond to two or more of: skill(s) of the candidate, organization(s) in which the candidate has worked, age of the candidate, gender of the candidate, nationality of candidate, contact details of the candidate, public profile links of the candidate, and the like. For instance, in each knowledge graph 107b, each edge connecting the primary node and a particular second node may indicate that the candidate has the skill(s), the age, the gender, the location, or the like.

In an embodiment, the processing module 105b may generate the set of first user input graphs 107c and the set of second user input graphs 107d by processing the user input data. For example, the user input data may include user feedback data and/or user co-search data. In an example embodiment, the processing module 105b may generate the set of first user input graphs 107c by processing the user feedback data. For instance, the user feedback data may include one or more user feedbacks such as a user (i.e., the talent acquisition professional) showing his/her willingness to recruit a particular candidate. In the talent acquisition platform 105, the willingness of the talent acquisition professional to recruit the candidate can be realized as the talent acquisition professional providing a good-fit (i.e., a positive feedback) to the candidate profile via the user equipment 109 associated with the talent acquisition professional. In an example embodiment, the processing module 105b may generate the set of first user input graphs 107c such that each first user input graph 107c corresponds to one or more user feedbacks provided by one particular talent acquisition professional. Each first user input graph 107c may include at least one primary node, a plurality of secondary nodes, and a plurality of edges connecting the primary node to the plurality of secondary nodes. For instance, the at least one primary node may correspond to the primary recruiting entity representing at least one talent acquisition professional. For instance, the plurality of secondary nodes may correspond to the plurality of candidate entities representing the plurality of candidates. For instance, in each first user input graph 107c, each edge connecting the talent acquisition professional and a particular candidate may indicate that the talent acquisition professional has given the positive feedback to the particular candidate.

In an example embodiment, the processing module 105b may generate the set of second user input graphs 107d by processing the user co-search data. For instance, the user co-search data may include data about search(s) performed by one or more talent acquisition professional using one or more organization names as search query(s). In an example embodiment, the processing module 105b may generate the set of second user input graphs 107d such that each second user input graph 107d corresponds to the search(s) performed by one particular talent acquisition professional. Each second user input graph 107d may include at least one primary node, a plurality of secondary nodes, and a plurality of edges connecting the primary node to the plurality of secondary nodes. For instance, the at least one primary node of each second user input graph 107d may correspond to the primary recruiting entity representing at least one talent acquisition professional. For instance, the plurality of secondary nodes of each second user input graph 107d may correspond to a plurality of secondary recruiting entities whose names were used to perform the search(s). For instance, in each second user input graph 107d, each edge may indicate that the talent acquisition professional has used the particular organization's name to perform the search.

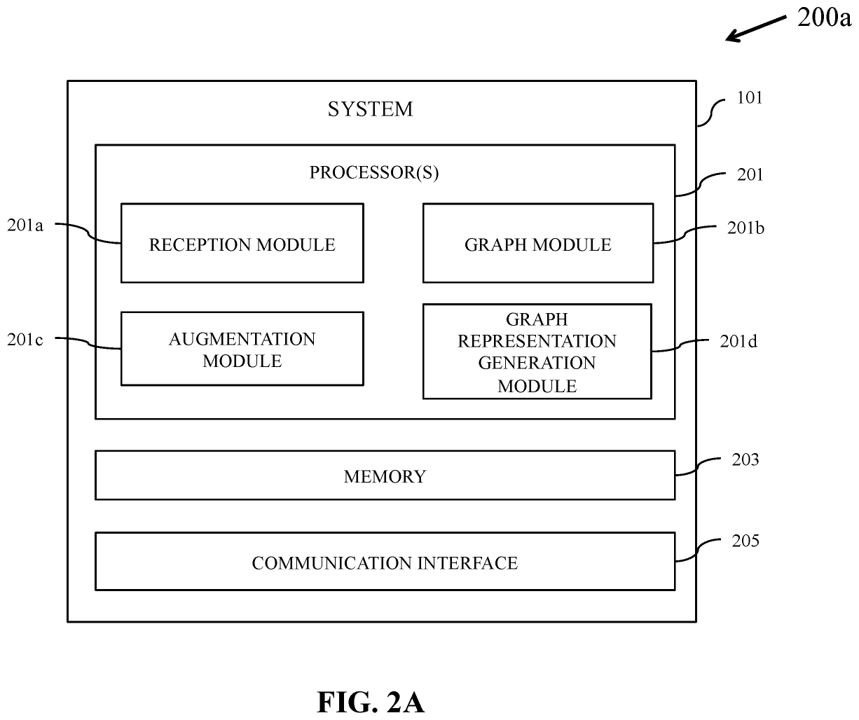

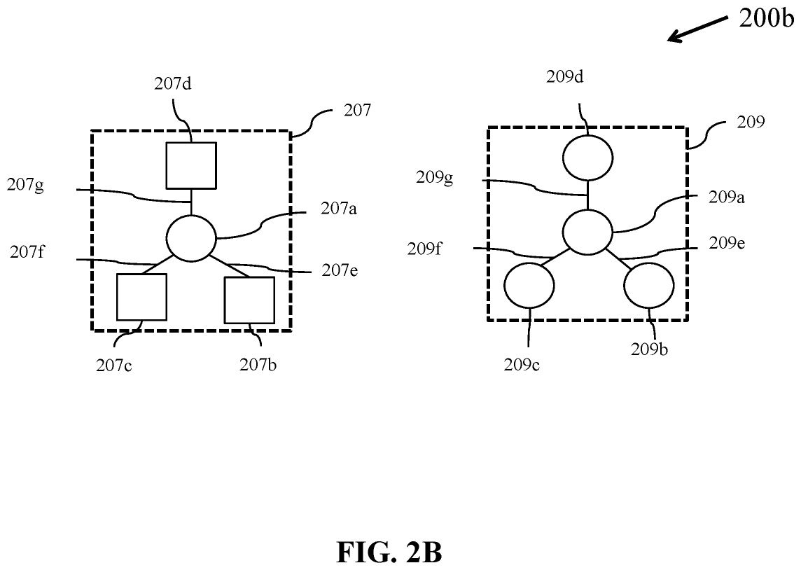

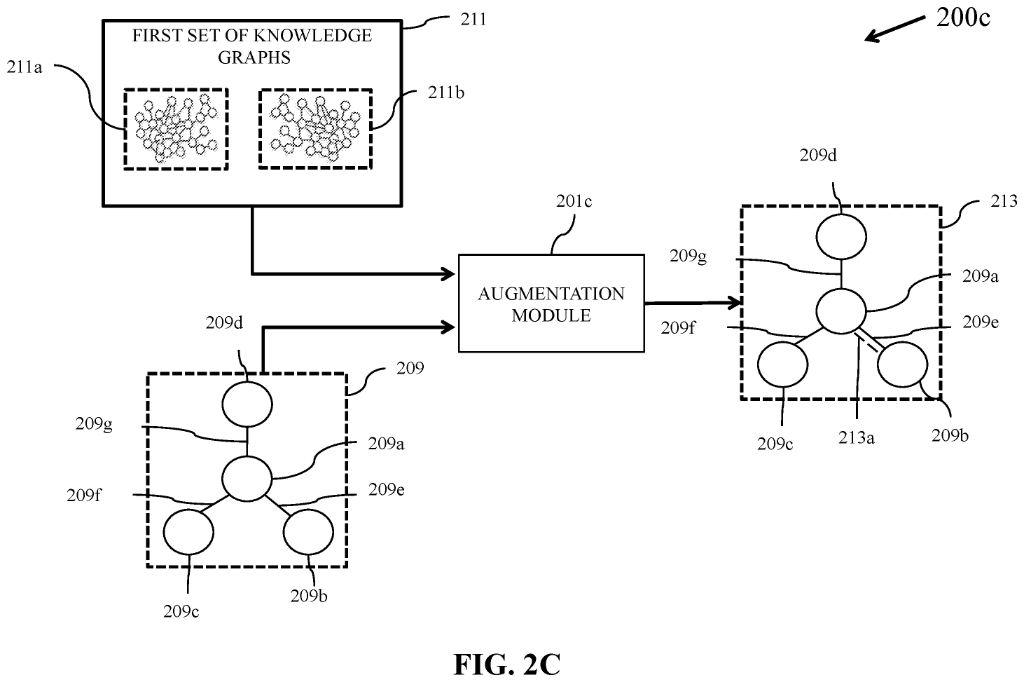

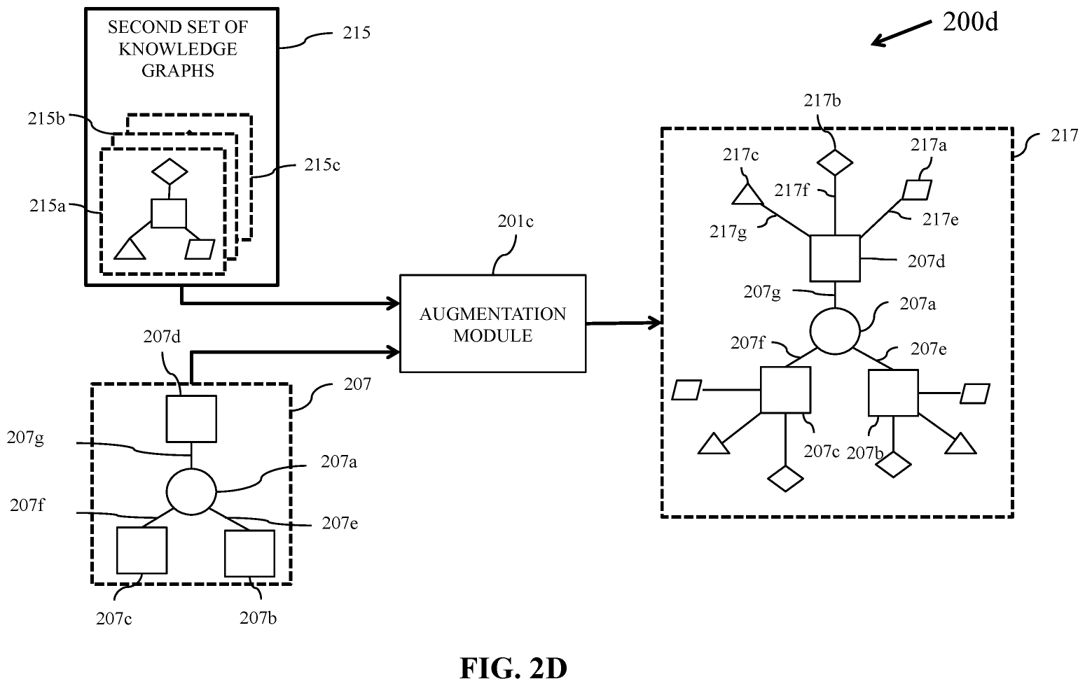

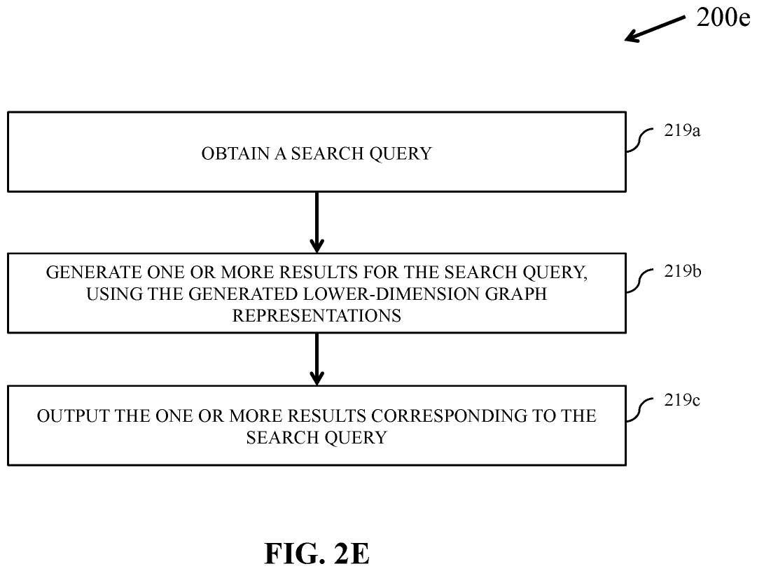

Some embodiments are based on the realization that the set of first user input graphs 107c and/or the set of second user input graphs 107d may be used to provide accurate and reliable results to the talent acquisition professional(s), when the talent acquisition professional(s) input a search query to recruit the candidates via the talent acquisition platform 105. Some embodiments are based on the recognition that the graphs of the set of first user input graphs 107c and/or the set of second user input graphs 107d may have complex structure. Thereby, the graphs of the set of first user input graphs 107c and/or the set of second user input graphs 107d may demand for more computational resources to provide the results using the graphs. For example, processing of the graphs having complex structure may demand for high-end processor, or the like. To this end, the system 101 may be provided to generate lower-dimension graph representations based on the set of first user input graphs 107c and/or the set of second user input graphs 107d. Further, the generated lower-dimension graph representations may be used to provide accurate and reliable results to the talent acquisition professional(s) such that the requirements of the computational resources may be reduced. For instance, a configuration of the system 101 for generating the lower-dimension graph representations is as explained in the detailed description of FIG. 2A.

FIG. 2A illustrates a block diagram 200a of the system 101 for generating the lower-dimension graph representations, in accordance with one or more example embodiments. FIG. 2A is explained in conjunction with FIG. 1A and FIG. 1B. The system 101 may include at least one processor 201, a memory 203, and a communication interface 205. Further, the system 101 may include a reception module 201a, a graph module 201b, an augmentation module 201c, and a graph representation generation module 201d.

According to an embodiment, each of the modules 201a-201d may be embodied in the processor 201. The processor 201 may retrieve computer-executable instructions that may be stored in the memory 203 for execution of the computer-executable instructions, which when executed configures the processor 201 for generating the linear feature data.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

Additionally, or alternatively, the processor 201 may include one or more processors capable of processing large volumes of workloads and operations to provide support for big data analysis. In an example embodiment, the processor 201 may be in communication with the memory 203 via a bus for passing information. The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the system 101 to carry out various functions in accordance with one or more example embodiment of the present disclosure. For example, the memory 203 may be configured to buffer input data for processing by the processor 201. As exemplarily illustrated in FIG. 2A, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present disclosure while configured accordingly. Thus, for example, when the processor 201 is embodied as an ASIC, FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

In some embodiments, the processor 201 may be configured to provide Internet-of-Things (IoT) related capabilities to a user. In some embodiments, the user may be or correspond to the talent acquisition professional looking for a suitable candidate. In some other embodiments, the user may be or correspond to an organization represented by its talent acquisition team having multiple talent acquisition professionals for recruiting the suitable candidate(s). The IoT related capabilities may in turn be used to provide provide accurate and reliable results to the talent acquisition professional(s), when a search query is received from the talent acquisition professional(s). The system 101 may be accessed using the communication interface 205. The communication interface 205 may provide an interface for accessing various features and data stored in the system 101. For example, the communication interface 205 may include I/O interface which may be in the form of a GUI, a touch interface, a voice enabled interface, a keypad, a keyboard, a mouse, a display unit, a monitor, and the like. For example, the communication interface 205 may be a touch enabled interface of a server computer or a remote desktop that displays a web interface or web page for the talent acquisition platform 105. The system 101 may provide various functionalities for generating the lower-dimension graph representations using the modules 201a-201d.

In an embodiment, the modules 201a-201d of the processor 201 may be used in conjunction with the memory 203 and the communication interface 205 to generate the lower-dimension graph representations for a graph, which may be further used to provide provide accurate and reliable results to the talent acquisition professional(s), when a search query is received from the talent acquisition professional(s). In an example embodiment, the modules 201a-201d may generate the lower-dimension graph representations for the graph to reduce the requirements of computation resources. As used herein, the lower-dimension graph representations correspond to vector representations of the graph that encode properties of the graph such as node-to-node relationships of the graph, nodes of the graph, and the like.

According to an embodiment, the reception module 201a may be configured to obtain a graph from a database (e.g. the database 107). The obtained graph may correspond to at least one of the first user input graph 107c or the second user input graph 107d. For instance, the graph obtained by the reception module 201a is as illustrated in FIG. 2B.

FIG. 2B illustrates a schematic diagram 200b showing graphs 207 and 209 obtained by the system 101, in accordance with one or more example embodiments. FIG. 2B is explained in conjunction with FIG. 1B. In one embodiment, the reception module 201a may obtain the graph 207. The graph 207 may correspond to the first user input graph of the set of first user input graphs 107c. The graph 207 may include a primary node 207a, a plurality of secondary nodes 207b, 207c, and 207d, and a plurality of edges 207e, 207f, and 207g. The primary node 207a may correspond to the primary recruiting entity that is indicative of the organization (or the talent acquisition professional(s) of the organization). The plurality of secondary nodes 207b, 207c, and 207d may correspond to the plurality of candidate entities that are is indicative of the plurality of candidates. The plurality of edges 207e, 207f, and 207g may indicate the talent acquisition professional(s) of the organization has given the positive feedback (i.e., the good-fit) to the plurality of candidates.

In another embodiment, the reception module 201a may obtain the graph 209. The graph 209 may correspond to the second user input graph of the set of second user input graphs 107d. The graph 209 may include a primary node 209a, a plurality of secondary nodes 209b, 209c, and 209d, and a plurality of edges 209e, 209f, and 209g. The primary node 209a may correspond to the primary recruiting entity that is indicative of the organization (or the talent acquisition professional(s) of the organization). The plurality of secondary nodes 209b, 209c, and 209d may correspond to the plurality of secondary recruiting entities that are is indicative of the plurality of secondary organizations. For example, the secondary recruiting entity represented by the secondary node may be different from the primary recruiting entity represented by the primary node. The plurality of edges 209e, 209f, and 209g may indicate the talent acquisition professional(s) of the primary recruiting entity has performed a search for recruiting the candidate(s) using the names of the plurality of the secondary recruiting entities.

Once the graph (e.g. the graph 207 or the graph 209) is obtained, the graph module 201b may be configured to determine the obtained graph as at least one a sparse graph or a dense graph. In an embodiment, the graph module 201b may determine the obtained graph as the sparse graph or the dense graph using primary connectivity and secondary connectivity data associated with the obtained graph. The primary connectivity data may include one or a combination of the user feedback data and the user co-search data. The secondary connectivity data may include one or a combination of the competitor list data, job hopping data, and/or the candidate data. Accordingly, the secondary connectivity data may be indicative of one or a combination of the first set of knowledge graphs 107a1 and 107a2 and/or the second set of knowledge graphs 107b.

In an example embodiment, to determine whether the graph is the sparse graph or the dense graph, the graph module 201b may determine whether each edge of the plurality of edges (e.g. the plurality of edges 207e, 207f, and 207g or the plurality of edges 207e, 207f, and 207g) is at least one of: (i) a primary connection defined by the primary connectivity data or (ii) a secondary connection defined by the secondary connectivity data. In an example embodiment, the primary connection may be indicative of the positive feedback given by the talent acquisition professional(s) to one particular candidate, when the primary connectivity data correspond to the user feedback data. In another example embodiment, the primary connection may be indicative of a search performed by the talent acquisition professional(s) using the name of one particular secondary recruiting entity, when the primary connectivity data corresponds to the user co-search data. In an example embodiment, the secondary connection may indicate that two connected nodes are competitor, when the secondary connectivity data corresponds to the competitor list data. In another example embodiment, the secondary connection may indicate that a job hopping of the candidate(s) has happened between the two connected nodes, when the secondary connectivity data corresponds to the job hopping data. In yet another embodiment, the secondary connection may indicate that the candidate has a particular skill, a particular location, or the like, when the secondary connectivity data corresponds to the candidate data.

Further, the graph module 201b may classify the obtained graph as the sparse graph, when each of the plurality of edges is a respective primary connection defined by the primary connectivity data. In other words, the graph module 201b may classify the obtained graph as the sparse graph, if the obtained graph corresponds to at least one of the first user input graph 107c or the second user input graph 107d. Additionally or Alternatively, the graph module 201b may classify the graph as the dense graph, when at least one edge of the plurality of edges is the secondary connection defined by the secondary connectivity data. In other words, the graph module 201b may classify the obtained graph as the dense graph, if the obtained graph does not correspond to at least one of the first user input graph 107c or the second user input graph 107d. In some implementations, the graph module 201b may also generate the graph(s) as explained in the detailed description of FIG. 1B, while the reception module 201a is configured to receive the user input data. Accordingly, in these implementations, the graph module 201b may not be limited only to determine whether the graph is the sparse graph or the dense graph. In other words, the graph module 201b may generate the graph (e.g. the graph 207 or the graph 209) in real-time, based on the user input data and further may determine whether the generated graph is the sparse graph or the dense graph.

In an embodiment, based on the determination that the obtained graph being the sparse graph, the augmentation module 201c may be configured to augment the obtained graph with the secondary connectivity data to produce an augmented graph. In an example embodiment, to augment the obtained graph with the secondary connectivity data, the augmentation module 201c may determine a node-category associated with the obtained graph. For instance, the node-category may be determined as at least one a heterogeneous node-category or a homogeneous node-category, based on the plurality of secondary nodes (e.g. the plurality of secondary nodes 207b, 207c, and 207d or the plurality of secondary nodes 209b, 209c, and 209d). For example, when the plurality of secondary nodes corresponds to the plurality of secondary recruiting entities, the augmentation module 201c may determine the node-category as the homogeneous category. In other words, if the nodes of the obtained graph corresponds entities of similar category, then the augmentation module 201c may determine the node-category as the homogeneous category. Alternatively, when the plurality of secondary nodes corresponds to the plurality of candidate entities, the augmentation module 201c may determine the node-category as the heterogeneous category. In other words, if the nodes of the obtained graph corresponds more than one category of entity, then the augmentation module 201c may determine the node-category as the heterogeneous category. Referring to FIG. 2B, if the obtained graph is the graph 207, the augmentation module 201c may determine the node-category as the heterogeneous category. Alternatively, if the obtained graph is the graph 209, the augmentation module 201c may determine the node-category as the homogenous category. For example, when the node-category is determined as the homogenous node-category, the augmentation module 201c may augment the graph 209 (i.e. the obtained graph) as explained in the detailed description of FIG. 2C.

FIG. 2C illustrates a schematic diagram 200c for producing an augmented graph 213 when the node-category corresponds to the homogenous node-category, in accordance with one or more example embodiments. Once the node-category is determined as the homogenous node-category, the augmentation module 201c may be configured to obtain a first set of knowledge graphs 211 as the secondary connectivity data. For example, the first set of knowledge graphs 211 may correspond to the first set of knowledge graphs 107a1 and 107a2 explained in the detailed description of FIG. 1B. In an example embodiment, the first set of knowledge graph 211 may include one or a combination of a competitor graph 211a and a job hopping graph 211b. For instance, the competitor graph 211a and the job hopping graph 211b may correspond to the competitor graph 107a1 and the job hopping graph 107a2 respectively. In an embodiment, based on the first set of knowledge graphs 211, the augmentation module 201c may augment the graph 209 to produce the augmented graph 213.

In an example embodiment, to produce the augmented graph 213, the augmentation module 201c may execute a first operation on the graph 209 and the first set of knowledge graphs 211. In an example embodiment, the first operation may define random walks on two or more of: the graph 209, the competitor graph 211a and the job hopping graph 211b. For instance, the first operation may correspond to the pre-trained models such as the ML models, NN models, and the like. For example, to define the random walks on one particular graph, the first operation may randomly select a node in the particular graph and identify an edge connecting the selected node to its neighboring node in the particular graph based on a predetermined distribution. Further, the first operation may iteratively repeat the process for next subsequent neighboring nodes of the particular graph to define the random walks on the particular graph. For instance, the predetermined distribution may be probability distribution that may be determined based on experimentation or the like.

Upon executing the first operation, the random walks on the graph 209, the random walks on the competitor graph 211a, and/or the random walks on the job hopping graph 211b may be obtained. Further, the augmentation module 201c may check, for each random walk of the random walks on the graph 209, whether there exists a corresponding random walk in the random walks on the competitor graph 211a and/or the random walks on the job hopping graph 211b. For example, for a random walk defined by the primary node 209a, the secondary node 209b, and the edge 209e, the augmentation module 201c may check whether there exists the corresponding random walk that would be defined the same primary and secondary nodes in the random walks on the competitor graph 211a and/or the random walks on the job hopping graph 211b. If the corresponding random walk exists, then the augmentation module 201c may identify an edge associated with the corresponding random walk as a secondary edge. Furthermore, the augmentation module 201c may augment the graph 209 with one or more identified secondary edges to produce the augmented graph 213. For purpose of explanation, considering the corresponding random walk exists for the random walk defined by the primary node 209a, the secondary node 209b, and the edge 209e. Accordingly, the edge associated with the random walk is identified a secondary edge 213a. To this end, the augmentation module 201c may augment the graph 209 with the secondary edge 213a to produce the augmented graph 213. For instance, the secondary edge 213a may be the secondary connection between the primary node 209a and the secondary node 209b.

In this way, the augmentation module 201c may produce the augmented graph 213, when the node-category is the homogenous node-category. Alternatively, if the node-category is the heterogeneous node-category, the augmentation module 201c may produce the augmented graph as explained in the detailed description of FIG. 2D.

FIG. 2D illustrates a schematic diagram 200d for producing an augmented graph 217 when the node-category corresponds to the heterogeneous node-category, in accordance with one or more example embodiments. Once the node-category is determined as the heterogeneous node-category, the augmentation module 201c may be configured to obtain a second set of knowledge graphs 215 as the secondary connectivity data. For instance, the second set of knowledge graphs 215 may correspond to the second set of knowledge graphs 107b explained in the detailed description of FIG. 1B. In an example embodiment, the second set of knowledge graphs 215 may include the knowledge graph associated with each of the plurality of secondary nodes 207b, 207c, and 207d. For example, the knowledge graphs 215a, 215b, and 215c may be associated with the plurality of secondary nodes 207b, 207c, and 207d respectively.

In an example embodiment, the augmentation module 201c may augment the graph 207 with the knowledge graphs 215a, 215b, and 215c to produce the augmented graph 217. For instance, the augmentation module 201c may identify the plurality of second nodes of each of the knowledge graphs 215a, 215b, and 215c as a plurality of tertiary nodes 217a, 217b, and 217c. Further, the augmentation module 201c may identify the plurality of edges of each of the knowledge graphs 215a, 215b, and 215c as a plurality of tertiary edges 217d, 217e, and 217f Furthermore, the augmentation module 201c may augment each secondary node of the graph 207 with the plurality of tertiary nodes 217a, 217b, and 217c and the plurality of tertiary edges 217d, 217e, and 217f For example, the secondary node 207b may be augmented with (i) the plurality of second nodes (i.e., the plurality of tertiary nodes) of the knowledge graph 215a and (ii) the plurality of edges (i.e., the plurality of tertiary edges) of the knowledge graph 215a. Similarly, the secondary nodes 207c and 207d may be augmented with the knowledge graphs 215b and 215c respectively.

In this way, the augmentation module 201c may produce the augmented graph 217, when the node-category is the heterogeneous node-category. Once the augmented graph (i.e., the augmented graph 213 or the augmented graph 217) is produced, the graph representation generation module 201d may be configured to generate the lower-dimension graph representations for the augmented graph. In one embodiment, to generate the lower-dimension graph representations for the augmented graph, the graph representation generation module 201d may execute the first operation on the augmented (i.e., the augmented graph 213 or the augmented graph 217) to obtain a plurality of random walks on the augmented graph. Further, the graph representation generation module 201d may generate a lower-dimension graph representation for each random walk obtained on the augmented graph. For instance, the lower-dimension graph representation may be a vector representation that encodes one particular random walk obtained on the augmented graph.

Some embodiments are based on the realization that the generation of the lower-dimension graph representations for entire augmented graph may be in-efficient. To this end, in another embodiment, the graph representation generation module 201d may be configured to select at least two node-types in the augmented graph. For instance, the graph representation generation module 201d may select the at least node-types in the augmented graph based on input(s) provided by a designer. Alternatively, the input(s) to select the at least node-types in the augmented graph may be predefined. In various embodiment, the primary node and the secondary nodes of the augmented graph (i.e. the augmented graph 213 or the augmented 217) may be selected as the node-types. In an example embodiment, the selected node types may define a sub-graph within the augmented graph. For instance, in the augmented graph 213, if the primary node and the secondary nodes are selected, entire augmented graph 213 may correspond to the sub-graph since the augmented graph 213 includes only the primary node and the secondary nodes. In the augmented graph 217, if the primary node and the secondary nodes are selected, the primary node, the secondary nodes and the edges connecting the primary node to the secondary nodes may correspond to the sub-graph. Once the at least two node-types are selected, the graph representation generation module may be configured to generate the lower-dimension representations for the sub-graph defined within the augmented graph. For instance, the lower-dimension representations for the sub-graph may be generated by executing the first operation on the sub-graph.

In this way, when the obtained graph is the sparse graph, the system 101 may be configured to generate the lower-dimension graph representations by producing the augmented graph. Alternatively, if the graph is the dense graph, the system 101 may generate the lower-dimension representations for entire dense graph or a sub-graph defined within the dense graph similarly as explained in conjunction in the augmented graph.

In some embodiments, when the node-category associated with the obtained graph is the heterogeneous node-category, the system 101 may further execute a second algorithm on the augmented graph (or the sub-graph of the augmented) or the dense graph (or the sub-graph of the dense graph) while generating the lower-dimension graph representations. In an example embodiment, the second operation may distinguish one node-type of the selected at least two node-types from another node-type of the selected at least two node-types. For instance, the second operation may distinguish the primary nodes from the secondary nodes. For example, the second operation may be an algorithm that performs normalization techniques (e.g. a category-specific normalization technique) to distinguish a primary node of one category from a secondary node (or a tertiary node) of another category. Accordingly, up on executing the second operation while generating the lower-dimension graph representations, the system 101 may be configured to generate the lower-dimension graph representations such that a first set of lower-dimension graph representations corresponding to one node-category is distinguishable from a second set of lower-dimension graph representations corresponding to another node-category where the first set of lower-dimension graph representations and the second set of lower-dimension graph representations are two subsets within the generated lower-dimension graph representations.

In this way, the system 101 may generate the lower-dimension graph representations in an efficient manner by considering the sparsity of the obtained graph and/or the node-category associated with the obtained graph. Further, the system 101 may use the generated lower-dimension graph representations to provide accurate and reliable results to the talent acquisition professional(s), when the talent acquisition professional(s) inputs a search query to recruit the candidates. For instance, the system 101 may use the generated lower-dimension graph representations to provide accurate and reliable results to the talent acquisition professional(s) as explained in the detailed description of FIG. 2E.

FIG. 2E illustrates a flowchart 200e for outputting one or more results corresponding to the search query, in accordance with one or more example embodiments. FIG. 2E is explained in conjunction with FIG. 2A and FIG. 1A. The flowchart 200e may be executed by the system 101. Starting at block 219a, the system 101 may obtain a search query. For instance, the system 101 may obtain the search query from the user equipment 109 associated with the talent acquisition professional. In an example embodiment, the search query may be indicative of one or a combination of skill data, educational data, location data, job role data, or company name data that the talent acquisition professional is looking from the candidate(s).

At block 219b, the system 101 may generate the one or more results for the search query, using the generated lower-dimension graph representations. In an example embodiment, to generate the one or more results, the system 101 may generate a vector representation for the search query. Further, the system 101 may determine, from the database 107, a plurality of candidate graphs (i.e. the knowledge graphs corresponding to the candidates) that match the vector representation of the search query along with the generated lower-dimension graph representations. Furthermore, the system 101 provide candidate data (i.e. the candidate profile(s)) associated with the plurality of candidate graphs as the one or more results for the search query. Since the system 101 determines the plurality of candidate graphs using the search query and the generated lower-dimension graph representations, the generated one or more results may be accurate and reliable results to the talent acquisition professional(s).

At block 219c, the system 101 may output the one or more results corresponding to the search query. For instance, the system 101 may output the one or more results (i.e., the candidate profile(s)) to the user equipment 109 associated with the talent acquisition professional. In this way, the system 101 may provide the accurate and reliable results to the talent acquisition professional(s) using the generated lower-dimension graph representations.

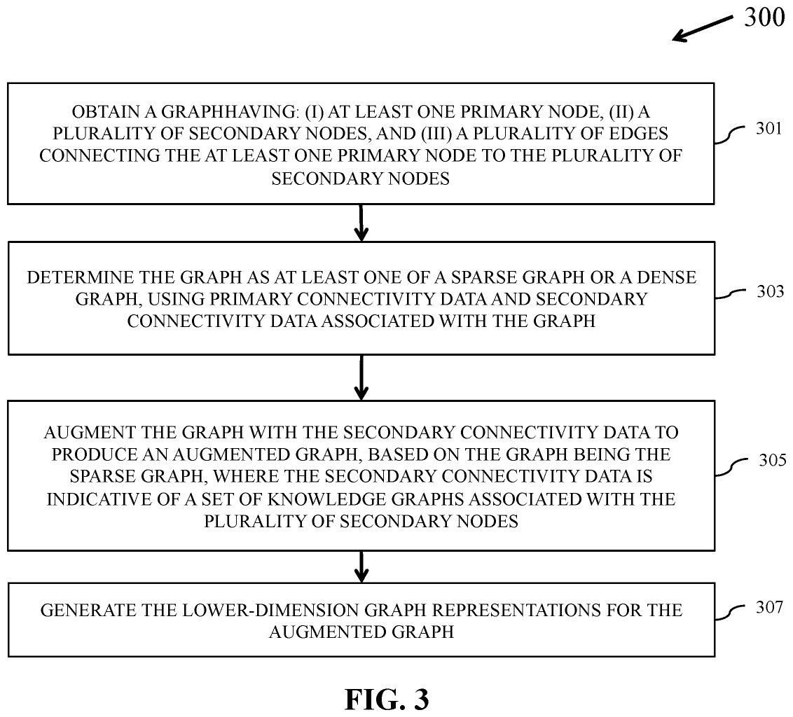

FIG. 3 illustrates a flowchart showing a method 300 for generating the lower-dimension graph representations, in accordance with one or more example embodiments. It will be understood that each block of the flow diagram of the method 300 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by the memory 203 of the system 101, employing an embodiment of the present invention and executed by the processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow chart support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Starting at block 301, the method 300 may include obtaining the graph having: (i) the at least one primary node, (ii) the plurality of secondary nodes, and (iii) the plurality of edges connecting the at least one primary node to the plurality of secondary nodes. For instance, the reception module 201a may obtain at least one of the graph 207 or the graph 209.

At block 303, the method 300 may include determining the graph as at least one of the sparse graph or the dense graph, using the primary connectivity data and the secondary connectivity data associated with the graph. For instance, the graph module 201b may determine the graph as at least one of the sparse graph or the dense graph, using the primary connectivity data and the secondary connectivity data.

At block 305, the method 300 may include augmenting the graph with the secondary connectivity data to produce the augmented graph, based on the graph being the sparse graph. For instance, the augmentation module 201c may augment the graph with the secondary connectivity data to produce the augmented graph (e.g., the augmented graph 213 or 217), based on the graph being the sparse graph. In an example embodiment, secondary connectivity data may be indicative of at least one of the first set of knowledge graphs or the second set of knowledge graphs.

At block 307, the method 300 may include generating the lower-dimension graph representations for the augmented graph. For instance, the graph representation generation module 201d may generate the lower-dimension graph representations for the augmented graph.

On implementing the method 300, the system 101 may generate the lower-dimension graph representations in an efficient manner, which may be further used to provide the accurate and reliable results to the talent acquisition professionals.

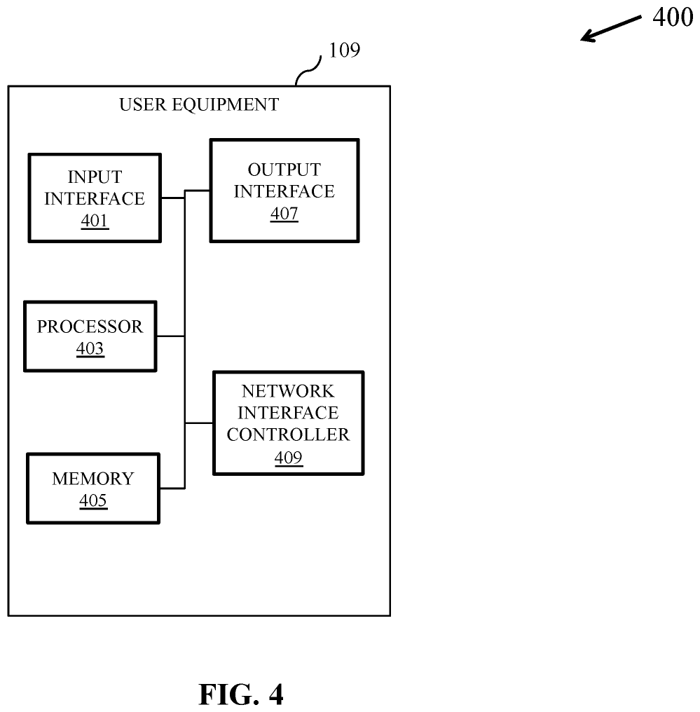

FIG. 4 illustrates a block diagram 400 of the user equipment 109 for accessing the talent acquisition platform 105, in accordance with one or more example embodiments. The user equipment 109 includes an input interface 401, at least one processor 403, a memory 405, an output interface 407, and a network interface controller 409, all components being interconnected by a bus for passing information.

The processor 403 executes computer-executable instructions, such as for accessing the talent acquisition platform 105 via one or more Application Programming Interface (API) calls, or via one or more network communication protocol messages. The processor 403 can include a general-purpose processor, a special-purpose processor, and combinations thereof. For example, the processor 403 can include a general-purpose central processing unit (CPU), a graphics processor, a processor in an application-specific integrated circuit (ASIC), a processor configured to operate using programmable logic (such as in a field-programmable gate array (FPGA)), and/or any other type of processor. In a multi-processing system, multiple processing units can be used to execute computer-executable instructions to increase processing power.

The memory 405 stores software implementing one or more innovations described herein, in the form of computer-executable instructions suitable for execution by the processor 403. Specifically, the memory 405 can be used to store computer-executable instructions, data structures, input data, output data, and other information. The memory 405 can include volatile memory (e.g., registers, cache, random-access memory (RAM)), non-volatile memory (e.g., read-only memory (ROM), electrically erasable programmable ROM (EEPROM), and flash memory), and/or combinations thereof. The memory 405 can include operating system software (not illustrated). Operating system software can provide an operating environment for other software executing in the user equipment 109 and can coordinate activities of the components of the user equipment 109.

The user equipment 109 may additionally include storage (not shown separately) that can include electronic circuitry for reading and/or writing to removable or non-removable storage media using magnetic, optical, or other reading and writing system that is coupled to the processor 403. The storage can include read-only storage media and/or readable and writeable storage media, such as magnetic disks, solid state drives, magnetic tapes or cassettes, CD-ROMs, CD-RWs, DVDs, or any other medium which can be used to store information and that can be accessed within the user equipment 109.

The user equipment 109 may include the network interface controller 409 for communicating with another computing entity using a communication medium (e.g., the network 103 shown in FIG. 1A).

The user equipment 109 may include the input interface 401 for interfacing with and receiving input signals from input device(s) from a physical environment. The input device(s) can include a tactile input device (e.g., a keyboard, a mouse, or a touchscreen), a microphone, a camera, a sensor, or another device that provides input to the user equipment 109.

The user equipment 109 may include the output interface 407 to provide an output interface to a user of the user equipment 109 and/or to generate an output observable in a physical environment using output device(s). The output device(s) can include a light-emitting diode, a display, a printer, a speaker, a CD-writer, or another device that provides output from the user equipment 109. In some examples, the input device(s) and the output device(s) may be used together to provide a user interface to a user of the user equipment 109.

The user equipment 109 is not intended to suggest limitations as to scope of use or functionality of the technology, as the technology can be implemented in diverse general-purpose and/or special-purpose computing environments. For example, the disclosed technology can be practiced in a local, distributed, and/or network-enabled computing environment. In distributed computing environments, tasks are performed by multiple processing devices. Accordingly, principles and advantages of distributed processing, such as redundancy, parallelization, and replication also can be implemented, as desired, to increase the robustness and performance of the devices and systems of the examples. The examples may also be implemented on computer system(s) that extend across any suitable network using any suitable interface mechanisms and traffic technologies, including by way of example only, wireless traffic networks, cellular traffic networks, Packet Data Networks (PDNs), the Internet, intranets, and combinations thereof.

The term computer-readable media includes non-transient media for data storage, such as memory 405 and storage 105c (shown in FIG. 1A) and does not include transmission media such as modulated data signals and carrier waves. Any of the disclosed methods can be implemented as computer-executable instructions stored on one or more computer-readable media and executed on a computer (e.g., any commercially available computer). Any of the computer-executable instructions for implementing the disclosed techniques as well as any data structures and data created and used during implementation of the disclosed embodiments can be stored on one or more computer-readable storage media. For example, the computer-executable instructions can be part of a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, or other such network) using one or more network-attached computers.

Accordingly, blocks of the methods shown by flow diagrams support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method for generating lower-dimension graph representations, the method comprising:
obtaining a graph having: (i) at least one primary node, (ii) a plurality of secondary nodes, and (iii) a plurality of edges connecting the at least one primary node to the plurality of secondary nodes;
determining the graph as at least one of a sparse graph or a dense graph, using primary connectivity data and secondary connectivity data associated with the graph;
based on the graph being the sparse graph, augmenting the graph with the secondary connectivity data to produce an augmented graph, wherein the secondary connectivity data is indicative of a set of knowledge graphs associated with the plurality of secondary nodes; and
generating the lower-dimension graph representations for the augmented graph.

2. The method of claim 1, wherein determining the graph as at least one of the sparse graph or the dense graph comprises:
determining that each of the plurality of edges is at least one of: (i) a primary connection defined by the primary connectivity data or (i) a secondary connection defined by the secondary connectivity data;
classifying the graph as the dense graph, in response to determining that at least one edge of the plurality edges is the secondary connection defined by the secondary connectivity data; or
classifying the graph as the sparse graph, in response to determining that each of the plurality of edges is a respective primary connection defined by the primary connectivity data.

3. The method of claim 1, wherein augmenting the graph with the secondary connectivity data comprises determining a node-category associated with the graph based on the plurality of secondary nodes, wherein the node-category corresponds to at least one of a heterogeneous node-category or a homogeneous node-category.

4. The method of claim 3, wherein the at least one primary node corresponds to at least one primary recruiting entity, wherein the plurality of secondary nodes corresponds to at least one of: (i) a plurality of candidate entities or (ii) a plurality of secondary recruiting entities, and wherein determining the node-category associated with the graph comprises:
determining the node-category as the heterogeneous node-category when the plurality of secondary nodes corresponds to the plurality of candidate entities; or
determining the node-category as the homogeneous node-category when the plurality of secondary nodes corresponds to the plurality of secondary recruiting entities.

5. The method of claim 4, wherein when the node-category of the graph corresponds to the homogeneous node-category, augmenting the graph with the secondary connectivity data further comprises:
obtaining a first set of knowledge graphs as the secondary connectivity data, wherein the first set of knowledge graphs comprises one or a combination of: a competitor graph or a job hopping graph associated with the plurality of secondary recruiting entities; and
based on the first set of knowledge graphs, augmenting the graph with one or more secondary edges to produce the augmented graph, wherein each of the one or more secondary edges is indicative of a secondary connection between the at least one primary node and the plurality of secondary nodes.

6. The method of claim 5, wherein augmenting the graph with the one or more secondary edges comprises executing a first operation on the graph and the first set of knowledge graphs to identify the one or more secondary edges, wherein the first operation defines random walks on at least two or more of: (i) the graph, (ii) the competitor graph, or (iii) the job hopping graph.

7. The method of claim 4, wherein when the node-category of the graph corresponds to the heterogeneous node-category, augmenting the graph with the secondary connectivity data further comprises:
obtaining a second set of knowledge graphs as the secondary connectivity data, wherein the second set of knowledge graphs comprises a knowledge graph associated with each of the plurality of candidate entities; and
based on the second set of knowledge graphs, augmenting the graph with (i) a plurality of tertiary nodes and (ii) a plurality of tertiary edges to produce the augmented graph.

8. The method of claim 1, wherein generating the lower-dimension graph representations for the augmented graph comprises:
selecting at least two node-types in the augmented graph, wherein the at least two node-types define a sub-graph within the augmented graph; and
generating the lower-dimension graph representations for the sub-graph defined within the augmented graph.

9. The method of claim 8, further comprising executing a second operation on the augmented graph to produce the lower-dimension graph representations for the sub-graph, wherein the second operation distinguishes one node-type of the at least two node-types from another node-type of the at least two node-types in the produced lower-dimension graph representations.

10. The method of claim 1, further comprising generating the lower-dimension graph representations for the graph, based on the graph being the dense graph.

11. The method of claim 1, further comprising:
obtaining a search query indicative of one or a combination of skill data, educational data, location data, job role data, or company name data;
generating one or more results for the search query, using the generated lower-dimension graph representations; and
outputting the one or more results corresponding to the search query.

12. A system for generating lower-dimension graph representations, the system comprising:
a memory configured to store computer-executable instructions; and
at least one processor configured to execute the computer-executable instructions to:
obtain a graph having: (i) at least one primary node, (ii) a plurality of secondary nodes, and (iii) a plurality of edges connecting the at least one primary node to the plurality of secondary nodes;
determine the graph as at least one of a sparse graph or a dense graph, using the primary connectivity data and secondary connectivity data associated with the graph;
based on the graph being the sparse graph, augment the graph with the secondary connectivity data to produce an augmented graph, wherein the secondary connectivity data is indicative of a set of knowledge graphs associated with the plurality of secondary nodes; and
generate the lower-dimension graph representations for the augmented graph.

13. The system of claim 12, wherein to determine the graph as at least one of the sparse graph or the dense graph, the at least one processor is configured to:
determine that each of the plurality of edges is at least one of: (i) a respective primary connection defined by the primary connectivity data or (ii) a respective secondary connection defined by the secondary connectivity data;
classify the graph as the dense graph, in response to determining that at least one edge of the plurality of edges is the respective secondary connection defined by the secondary connectivity data; or
classify the graph as the sparse graph, in response to determining that each of the plurality of edges is the respective primary connection defined by the primary connectivity data.

14. The system of claim 12, wherein to augment the graph with the secondary connectivity data, the at least one processor is configured to determine a node-category associated with the graph based on the plurality of secondary nodes, wherein the node-category corresponds to at least one of a heterogeneous node-category or a homogeneous node-category.

15. The system of claim 14, wherein the at least one primary node corresponds to at least one primary recruiting entity, wherein the plurality of secondary nodes corresponds to at least one of: (i) a plurality of candidate entities or (ii) a plurality of secondary recruiting entities, and wherein to determine the node-category associated with the graph, the at least one processor is configured to:
determine the node-category as the heterogeneous node-category when the plurality of secondary nodes corresponds to the plurality of candidate entities; or
determine the node-category as the homogeneous node-category when the plurality of secondary nodes corresponds to the plurality of secondary recruiting entities.

16. The system of claim 15, wherein when the node-category of the graph corresponds to the homogeneous node-category, the at least one processor is configured to:
obtain a first set of knowledge graphs as the secondary connectivity data, wherein the first set of knowledge graphs comprises one or a combination of: a competitor graph or a job hopping graph associated with the plurality of secondary recruiting entities; and
based on the first set of knowledge graphs, augment the graph with one or more secondary edges to produce the augmented graph, wherein each of the one or more secondary edges is indicative of a secondary connection between the at least one primary node and the plurality of secondary nodes.

17. The system of claim 16, wherein to augment the graph with the one or more secondary edges, the at least one processor is configured to execute a first operation on the graph and the first set of knowledge graphs to identify the one or more secondary edges, wherein the first operation defines random walks on at least two or more of: (i) the graph, (ii) the competitor graph, or (iii) the job hopping graph.

18. The system of claim 15, wherein when the node-category of the graph corresponds to the heterogeneous node-category, the at least one processor is configured to:
obtain a second set of knowledge graphs as the secondary connectivity data, wherein the second set of knowledge graphs comprises a knowledge graph associated with each of the plurality of candidate entities; and
based on the second set of knowledge graphs, augment the graph with (i) a plurality of tertiary nodes and (ii) a plurality of tertiary edges to produce the augmented graph.

19. The system of claim 12, wherein to generate the lower-dimension graph representations for the augmented graph, the at least one processor is configured to:
select at least two node-types in the augmented graph, wherein the at least two node-types define a sub-graph within the augmented graph; and
generate the lower-dimension graph representations for the sub-graph defined within the augmented graph.

20. A computer program product comprising a non-transitory computer readable medium having stored thereon computer executable instruction which when executed by at least one processor, cause the at least one processor to carry out operations for generating lower-dimension graph representations, the operation comprising:
obtaining a graph having: (i) at least one primary node, (ii) a plurality of secondary nodes, and (iii) a plurality of edges connecting the at least one primary node to the plurality of secondary nodes;
determining the graph as at least one of a sparse graph or a dense graph, using primary connectivity data and secondary connectivity data associated with the graph;
based on the graph being the sparse graph, augmenting the graph with the secondary connectivity data to produce an augmented graph, wherein the secondary connectivity data is indicative of a set of knowledge graphs associated with the plurality of secondary nodes; and
generating the lower-dimension graph representations for the augmented graph.
